(19) United States
(12) Patent Application Publication
(10) Pub. No.: US 2024/0343147 A1
(43) Pub. Date: Oct. 17, 2024

(54) DETECTION AND MITIGATION OF CHARGING SIGNAL OSCILLATIONS DURING OFFBOARD CHARGING EVENT

(71) Applicant: GM GLOBAL TECHNOLOGY OPERATIONS LLC, Detroit, MI (US)

(72) Inventors: Jacob Hollingsworth, Livonia, MI (US); Christopher Rowe, Hartland, MI (US); Michael P. Kolb, Lake Orion, MI (US); Alan Zhen, Livonia, MI (US); Kristina Goel, Commerce Township, MI (US)

(73) Assignee: GM GLOBAL TECHNOLOGY OPERATIONS LLC, Detroit, MI (US)

(21) Appl. No.: 18/299,192

(22) Filed: Apr. 12, 2023

(51) Int. Cl. B60L 53/62; B60K 1/04; B60L 53/30; B60L 53/66

(52) U.S. Cl. CPC B60L 53/62; B60K 1/04; B60L 53/305; B60L 53/66; B60K 2001/0438

(57) ABSTRACT

An electrified powertrain system including a battery pack, electric motor, and a local controller. In response to a connection of the battery pack to an offboard charging station having a station controller, the local controller receives a reported charging limit from and transmits an initial charge request signal to the station controller. The initial charge request signal is a request for charging power or current at the reported charging limit. The vehicle controller also detects a threshold oscillation of the charging limit during an active charging event during which the battery pack recharges. In response to the threshold oscillation during the active charging event, the vehicle controller temporarily reduces the initial charge request to a derated level.

### INTRODUCTION

Battery electric vehicles, hybrid electric vehicles, and plug-in hybrid electric vehicles, collectively referred to herein as electric vehicles (EVs) for simplicity, are equipped with electrified powertrain systems having a high-energy propulsion battery pack and one or more electric traction motors. The propulsion battery pack forms a core component of a rechargeable energy storage system (RESS), with constituent electrochemical battery cells of the battery pack being rechargeable as needed using offboard charging power and onboard regenerative braking.

During a typical offboard charging event, two-way communication occurs via an established protocol between an onboard vehicle controller and a counterpart station controller of a charging station/electric vehicle supply equipment (EVSE). This connection results in, among other things, the communication of a charging request from the vehicle controller to the station controller. The station controller in turn informs the vehicle controller of the station's charging limits. Charging of the battery pack commences upon the successful exchange of the requisite parameters and charging limits.

Public charging networks include offboard charging stations from an ever-increasing number of EVSE manufacturers. Direct current fast-charging (DCFC) stations in particular use multiple power conversion stages to convert an alternating current (AC) supply voltage to DC power suitable for charging the propulsion battery pack. A given offboard charging station may use a manufacturer-specific internal power conversion setup. As a result, a charging vehicle could encounter oscillating power or current limits as the charging station toggles between available power conversion stages. Such toggling, which temporarily reduces the charging station's output capability, is typically prevalent when the charging station operates close to its established charging limits.

### SUMMARY

Disclosed herein are hardware and software-based solutions for detecting and mitigating undesirable oscillations in charging power or current limits provided by an offboard charging station during a battery charging event. The present solutions could be implemented aboard a charge recipient system, e.g., a motor vehicle having a rechargeable propulsion battery pack, or the solutions could be implemented preemptively aboard the offboard charging station.

As exemplified herein, the battery charging event is a direct current fast-charging (DCFC) event during which high-voltage charging power is provided by the offboard charging station to a propulsion battery pack of an electric vehicle (EV). However, the present teachings could also be applied to other mobile or stationary systems having a similar rechargeable battery pack suitable for use with the offboard charging station described herein.

In a particular non-limiting implementation, an electrified powertrain system includes a battery pack, a power inverter, an electric motor, and a local controller, i.e., an onboard electronic control unit or processor. The local controller is configured, in response to a connection of the battery pack to an offboard charging station having a station controller, to receive a reported charging limit from the station controller, e.g., as a power and/or current limit. The local controller in this embodiment also transmits a charge request signal, e.g., a power or current request, to the station controller. The charge request signal is based on the reported charging limit, with the local controller typically requesting charging power/current at or near the reported limits.

As part of its programmed functionality, the local controller in the various embodiments set forth herein may detect a threshold oscillation of the reported charging limits during an active charging event. The active charging event as contemplated herein is one during which the aforementioned battery pack is recharged by the offboard charging station. The local controller in a possible implementation adjusts its charge request signal in real-time during the active charging event, with this action occurring in response to the threshold oscillation.

The reported charging limit may include a maximum charging power limit of the offboard charging station, in which case the initial charge request is a request for the charging power at the maximum charging power limit.

The local controller may count a number of step-like oscillations in the reported charging limit over a predetermined duration as a rate of change (ROC). In this implementation, the local control could detect the threshold oscillation by comparing the ROC to a calibrated ROC value.

The local controller in a possible embodiment may also hold the derated level for a calibrated amount of time, and resume the initial charge request when the calibrated amount of time has elapsed. The local controller could also detect the threshold oscillation by recording a minimum point in the oscillations in memory of the local controller. The derated level is below the minimum point in this particular embodiment.

The electrified powertrain system may be used aboard a motor vehicle having a set of road wheels, in which case the battery pack is a propulsion battery pack of the motor vehicle and the electric motor is connected to one or more of the road wheels.

In one or more embodiments, the threshold oscillation is at least 5 percent of the maximum power or current limit.

The local controller could be in communication with a user device and configured to transmit a station status signal to the user device that is indicative of the threshold oscillation.

Also disclosed herein is a method for charging a battery pack of an electrified powertrain system. The method in accordance with a possible embodiment includes receiving a reported charging limit from a station controller of an offboard charging station in response to a connection of the battery pack to the offboard charging station, as well as transmitting an initial charge request to the station controller via a local controller of the electrified powertrain system.

The initial charging current request in this embodiment is a request for charging power or current at the reported charging limit. The method may also include detecting a threshold oscillation of the reported charging limit, via the local controller, during an active charging event during which the battery pack is recharged via the offboard charging station. In response to the threshold oscillation, the method may include temporarily reducing the initial charge request to a derated level via the local controller during the active charging event.

A method for charging a battery pack of an electrified powertrain system is also disclosed herein. An embodiment of this method includes receiving, via a first controller, an initial charge request from a second controller while the battery pack is connected to an offboard charging station. The method includes detecting a threshold oscillation of a charging limit of the offboard charging station, via the first controller or the second controller, during an active charging event during which the battery pack of the electrified powertrain system is recharged by the offboard charging station. In response to the threshold oscillation, the method in this embodiment includes temporarily reducing the charging limit of the offboard charging station to a derated charging limit during the active charging event.

The offboard charging station may include a station controller as the first controller, and detecting the threshold oscillation of the charging limit and temporarily reducing the charging limit to the derated charging limit are performed by the station controller.

The station controller may be in communication with a user device, in which case the method may optionally include transmitting a station status signal to the user device via the station controller, the station status signal being indicative of the threshold oscillation and the derated charging limit.

As noted above, the electrified powertrain system could be a component of a motor vehicle having a vehicle controller, a vehicle body, a set of road wheels connected to the vehicle body, and an electric traction motor connected to one or more of the road wheels and energized by the battery pack. The first controller in this instance may be a station controller of the offboard charging station. The second controller may be the vehicle controller.

The station controller in one or more embodiments may be configured to count a number of step-like oscillations in the reported charging limit over a predetermined duration as an ROC, detect the threshold oscillation by comparing the ROC to a calibrated ROC value, hold the derated charging limit for a calibrated amount of time, and resume the initial charging current request when the calibrated amount of time has elapsed.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 illustrates a motor vehicle equipped with an electrified powertrain system having a rechargeable energy storage system (RESS) and a vehicle controller configured to detect and mitigate oscillations in charging limits from an offboard charging station.

FIG. 2 illustrates a representative embodiment of the electrified powertrain system of FIG. 1.

FIG. 3 is a representative station power limits and vehicle current requests for the offboard charging station illustrated in FIG. 1.

FIG. 4 is a station power limit and vehicle current request for the offboard charging station illustrated in FIG. 1 in accordance with an aspect of the disclosure.

FIG. 5 is a flow chart describing a method for diagnosing and mitigating charging limit oscillations in accordance with the disclosure.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

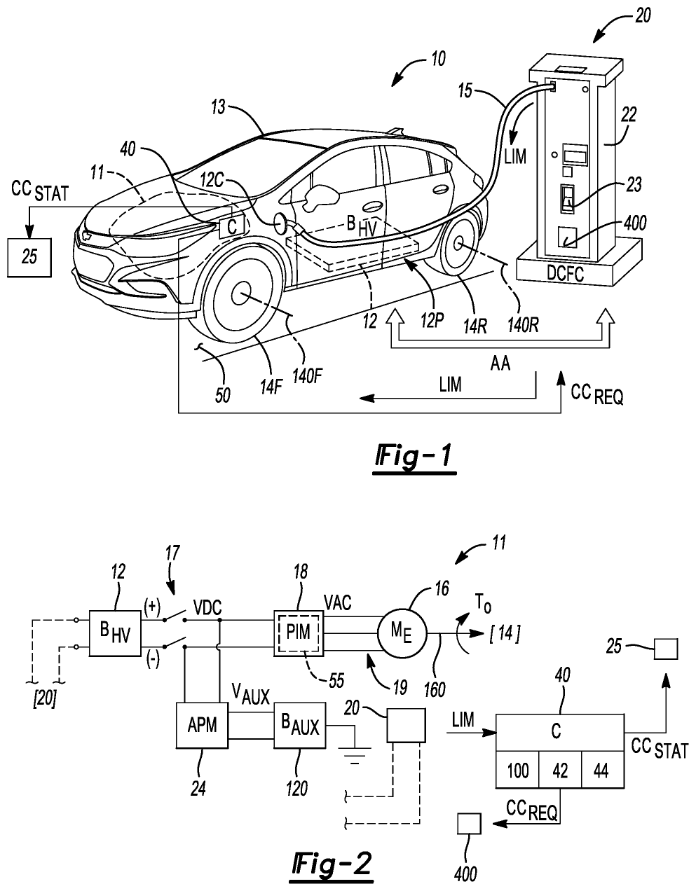

Referring to the drawings, wherein like reference numerals correspond to like or similar components throughout the several Figures, a motor vehicle 10 as shown in FIG. 1 is equipped with an electrified powertrain system 11. The electrified powertrain system 11, an example configuration of which is shown in more detail in FIG. 2, includes a power supply 12P. The power supply 12P in the non-limiting embodiment of FIG. 1 is configured as a high-voltage propulsion battery pack (B_{HV}) 12. As used herein, the term “high-voltage” may encompass battery voltages of about 60-300 volts (V) or more, i.e., a battery voltage level suitable for assisting or powering vehicular propulsion functions.

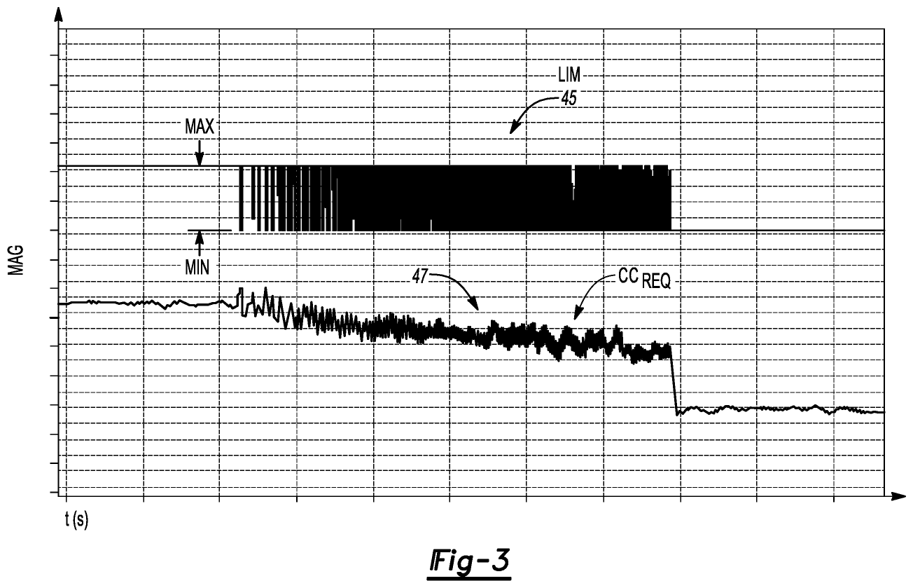

The representative motor vehicle 10 of FIG. 1 is configured to be selectively recharged via an offboard charging station 20. The offboard charging station 20 as contemplated herein is a direct current fast-charging (DCFC) station capable of outputting a DC charging voltage to the propulsion battery pack 12 during a battery charging event. Typically, such an offboard charging station 20 includes a weatherproof charging cabinet 22 having a cradle 23. Charging power or current is provided by the offboard charging station 20 over an electrical cable 15. A charge coupler (not shown) disposed on a distal end of the electrical cable 15 engages mating receptacles of a charging port 12C arranged on a vehicle body 13 of the motor vehicle 10. Undesirable oscillations in charging limits (LIM) of the offboard charging station 20 could occur once the charging event has commenced. The present solutions are directed toward detecting and mitigating such oscillations in the reported charging limits (LIM) during the battery charging event using an exemplary method 100 as described below with reference to FIGS. 3-5.

The exemplary motor vehicle 10 illustrated in FIG. 1 may be constructed as a battery electric vehicle or a hybrid electric vehicle having the aforementioned vehicle body 13 connected to/supporting the propulsion battery pack 12. During discharge/propulsion operating modes, electrical energy stored in constituent electrochemical battery cells (not shown) of the propulsion battery pack 12 powers the rotation of one or more road wheels 14F and/or 14R of the motor vehicle 10, with the road wheels 14F operating as front road wheels and the road wheels 14R operating as rear road wheels in the illustrated four-wheel configuration. Other possible embodiments of the motor vehicle 10 may have more or fewer road wheels as appreciated in the art. Rotation of the road wheels 14F and/or 14R about a corresponding drive axis 140F or 140R during discharge operating modes ultimately propels the motor vehicle 10 along a road surface 50.

During the representative offboard charging event depicted in FIG. 1, the propulsion battery pack 12 is recharged via the offboard charging station 20. Two-way communication between a vehicle controller (C) 40 of the motor vehicle 10 (or another local controller in non-vehicular applications) and a resident station controller 400 of the offboard charging station 20 is indicated by double-headed arrow AA. The respective vehicle and station controllers 40 and 400 are therefore representative of different first and second controllers within the scope of the disclosure. Upon establishing communication between the vehicle controller 40 and the station controller 400, the station controller 400 informs the vehicle controller 40 of its charging limits (LIM), e.g., its power and/or current limits, or perhaps temperature limits or other relevant performance limits. The vehicle controller 40 for its part transmits a charging current request signal (CC_{REQ}) to the station controller 400 to request a particular charging current at the limits of the offboard charging station 20.

As noted above, the charging limits (LIM) could oscillate at times, particularly when the offboard charging station 20 is outputting charging power or current at or near the charging limits (LIM). The vehicle controller 40 and/or the station controller 400 are therefore configured to detect and mitigate such oscillations as part of the present control strategy. To this end, the vehicle controller 40 and the station controller 400 mutually communicate using low-voltage signals, as appreciated in the art.

The vehicle controller 40 could also be in communication with a user device 25 (also see FIG. 2), e.g., a smartphone, tablet, or desktop computer via an associated program or application (“app”), in which case the vehicle controller 40 could selectively transmit a station status signal (CC_{STAT}). The station status signal (CC_{STAT}) in this implementation is indicative of the threshold oscillation. When the charging event is complete, an operator disconnects the charge coupler (not shown), closes a cover to the charging port 12C, and sets the charge coupler back into the cradle 23 of the charging cabinet 22 for later use.

Referring briefly to FIG. 2, the electrified powertrain system 11 in accordance with an exemplary embodiment includes the propulsion battery pack (B_{HV}) 12, a power inverter module (PIM) 18, and an electric traction motor (M_{E}) 16 connected to a rotatable output member 160. Certain configurations of the electrified powertrain system 11 may include more than one electric motor and/or more than one inverter. The representative PIM 18 for its part includes power switches 55 collectively configured and controlled to provide an alternating current (AC) output voltage (VAC) to the electric traction motor 16 via associated phase windings 19.

The propulsion battery pack 12 illustrated schematically in FIG. 2 is electrically connected to the PIM 18 via positive (+) and negative (−) high-voltage contactors 17. Although omitted for illustrative simplicity, the propulsion battery pack 12 is also selectively connectable to positive and negative terminals of a DC charge receptacle and input switches, with such a DC charge receptacle being electrically connected to the DC charge port 12C of FIG. 1 during charging modes of the propulsion battery pack 12. Charging power is thus supplied by the offboard charging station 20 through the DC charge port 12C of FIG. 1 via such positive and negative links and input switches.

During discharging/drive modes of the motor vehicle 10 shown in FIG. 1, the PIM 18 of FIG. 2 may be controlled with pulse width modulation or another application-suitable switching control technique to energize the phase windings 19 of the electric traction motor 16. In the non-limiting construction of FIG. 2, the electric traction motor 16 is a polyphase alternating current motor, in this instance a three-phase motor. The energized electric traction motor 16 generates and transfers output torque (arrow To) to the connected output member 160. The output member 160 for its part is mechanically coupled to a load, which in the representative embodiment of FIG. 1 includes one or more of the front road wheels 14F and/or the rear road wheels 14R. Torque delivery to the front/rear road wheels 14F/14R is indicated as “[14]” in FIG. 2 for simplicity.

The electrified powertrain system 11 may include additional electrical components for powering various systems or functions. For example, the propulsion battery pack 12 may be connected to an accessory power module (APM) 24 in the form of a DC-DC converter suitable for reducing a level of a DC voltage (VDC) of the propulsion battery pack 12 to a typical 12-15V auxiliary voltage level. An auxiliary battery (B_{AUX}) 120 such as a lead-acid auxiliary battery may be electrically connected to the APM 24, with internal switching operation of the APM 24 ensuring that the auxiliary battery 120 remains charged via an auxiliary voltage (V_{AUX}), or that one or more low-voltage systems, e.g., a radio, lighting, display screen, etc., are provided with power sufficient for energizing their respective functions.

Within the representative electrified powertrain system 11 illustrated in FIG. 2, the vehicle controller 40 receives the above-noted charging limits (LIM) from the offboard charging station 20. In response to receipt of the charging limits (LIM), the vehicle controller (C) 40 outputs the charge request (CC_{REQ}) as an electronic signal to the station controller 400. In order to perform the present method 100, the vehicle controller 40 is also equipped with one or more processors 42 and memory 44. Computer-readable instructions embodying the present method 100 may be stored in the memory 44, which may include tangible, non-transitory computer-readable storage medium, e.g., magnetic or optical media, CD-ROM, and/or solid-state/semiconductor memory (e.g., various types of RAM or ROM).

The term “controller” and related terms such as control module, module, control, control unit, processor, and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The non-transitory components of the memory 44 are capable of storing machine-readable instructions in the form of one or more software or firmware programs or routines, combinational logic circuit(s), input/output circuit(s) and devices, signal conditioning and buffer circuitry and other components that can be accessed by one or more processors 42 to provide a described functionality.

Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example about 50-100 microsecond (ms) intervals during ongoing operation. Alternatively, routines may be executed in response to occurrence of a triggering event.

Referring now to the time plot of FIG. 3, where time (t) is represented in seconds(s) on the horizontal axis and a unitless magnitude (MAG) is represented on the vertical axis, the charge limits (LIM) 45 communicated by the offboard charging station 20 of FIGS. 1 and 2 are shown exhibiting the characteristic oscillations addressed herein. As appreciated in the art, charging stations capable of performing DCFC events are made up of a station-specific number of power conversion modules in the form of DC-to-AC converters, with each power conversion module being sized and controlled in accordance with the manufacturer's preferred configuration.

As one or more power modules toggle on and off to respectively provide more or less charging power capability over a short duration, the offboard charging station 20 will tend to exhibit oscillating limits. This undesirable pattern is represented in FIG. 3 by the oscillating charge limits (LIM) 45 and its associated maximum and minimum limits [MAX, MIN]. For example, a maximum limit of about 200 kW and a minimum limit of about 185 kW could be experienced for a nominal charging power level of 190 kW, for a total possible oscillation magnitude of 10 kW, or about 5 percent of the nominal power limit in this particular example. Other oscillations could be greater or less than 10 kW, and thus the actual experienced oscillations will vary with the particular construction and operation of the offboard charging station 20.

Also shown in FIG. 3 is a trace 47 representing the charge request (CC_{REQ}) from the vehicle controller 40. This electronic signal attempts to follow the oscillating charge limits 45. As a result, trace 47 will likewise oscillate. A user of the motor vehicle 10 of FIG. 1 could perceive this as erratic feedback, e.g., at the offboard charging station 20 or via a display (not shown) of the motor vehicle 10, or via the user device 25 of FIGS. 1 and 2. Other potentially detrimental hardware effects might occur over time in the event such oscillating charge limits (LIM) 45 continue unabated, i.e., absent adoption of the present teachings.

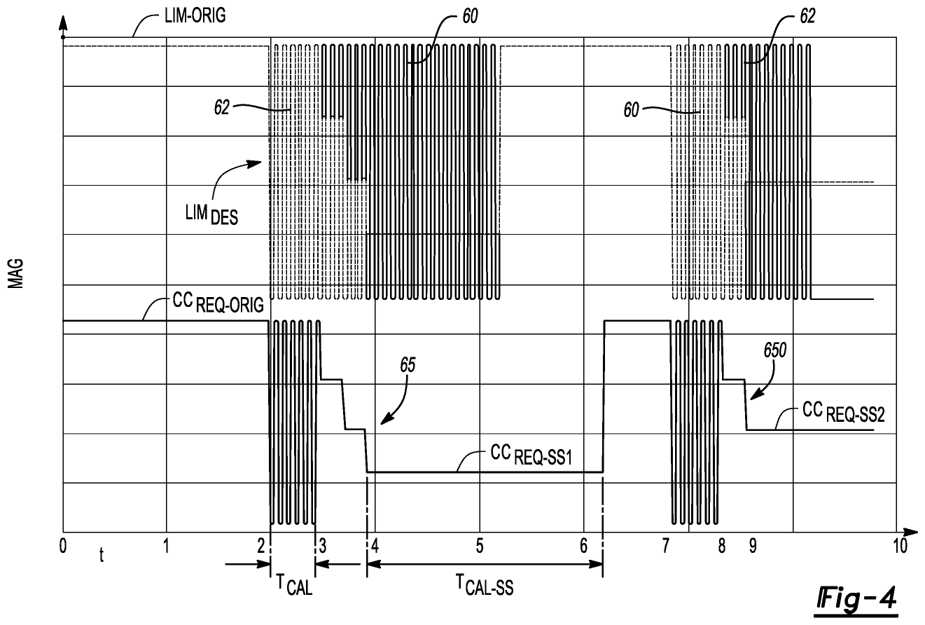

Referring now to FIG. 4, traces 60 and 62 together represent exemplary power limits (LIM) from the offboard charging station 20 of FIGS. 1 and 2. Time in unitless/nominal increments appears on the horizontal axis. Original limits (LIM-ORIG) are communicated in response to an original charge request (CC_{REQ-ORIG}) between t=0 and t=2. Trace 60 encompasses trace 62, i.e., the oscillating power limits extending from t=2 to t=5 without intervention of the vehicle controller 40. Trace 60 is thus hypothetical and is shown for the purpose of comparison. Trace 62 in turn represents a desired power limit (LIM_{DES}) as communicated by the offboard charging station 20 in response to performance of the present method 100. Thus, trace 62 of FIG. 4 is a subset of hypothetical trace 60 and represents a departure from trace 60 commencing at about t=3.

As depicted in FIG. 4, the vehicle controller 40 of FIGS. 1 and 2 transmits the original charge request (CC_{REQ-ORIG}) to the station controller 400 at t=0. Until about t=2, the motor vehicle 10 would therefore receive charging power at the original charging limits (LIM-ORIG) of the offboard charging station 20. In the illustrated example, however, the charging limits begin to oscillate starting at about t=2.

In response to this phenomenon, the vehicle controller 40 of FIGS. 1 and 2 in one or more embodiments waits through a calibrated duration (T_{CAL}), which in a non-limiting embodiment could be about 20-30 seconds. If the oscillations continue after this time point, the vehicle controller 40 of FIGS. 1 and 2 commences derating of the original charge request (CC_{REQ-ORIG}), as represented in FIG. 4 by a representative derating region 65. The vehicle controller 40 then enters a holding or steady-state period (T_{CAL-SS}) starting at about t=4, which may be about 100-110 s in a possible implementation. Here, the vehicle controller 40 transmits a steady-state charge request (CC_{REQ-SS1}), i.e., at a steady-state level (unchanging), that is less than the original steady-state charge request (CC_{REQ-ORIG}) between t=0 and t=2.

As part of the present control strategy, the vehicle controller 40 then increases its charge request (CC_{REQ}) to its original level (CC_{REQ-ORIG}) while the method 100 repeats, and addressing problematic oscillations should they arise again, as they do in FIG. 4 starting at about t=7. In the subsequent derating region 650, the vehicle controller 40 may employ fewer derating steps to arrive at a different steady-state value (CC_{REQ-SS2}) from t=9 until at least t=10. In this exemplary instance, the steady-state value (CC_{REQ-SS2}) is higher than the steady-state charge request (CC_{REQ-SS1}), although this will not necessarily be the outcome in other applications.

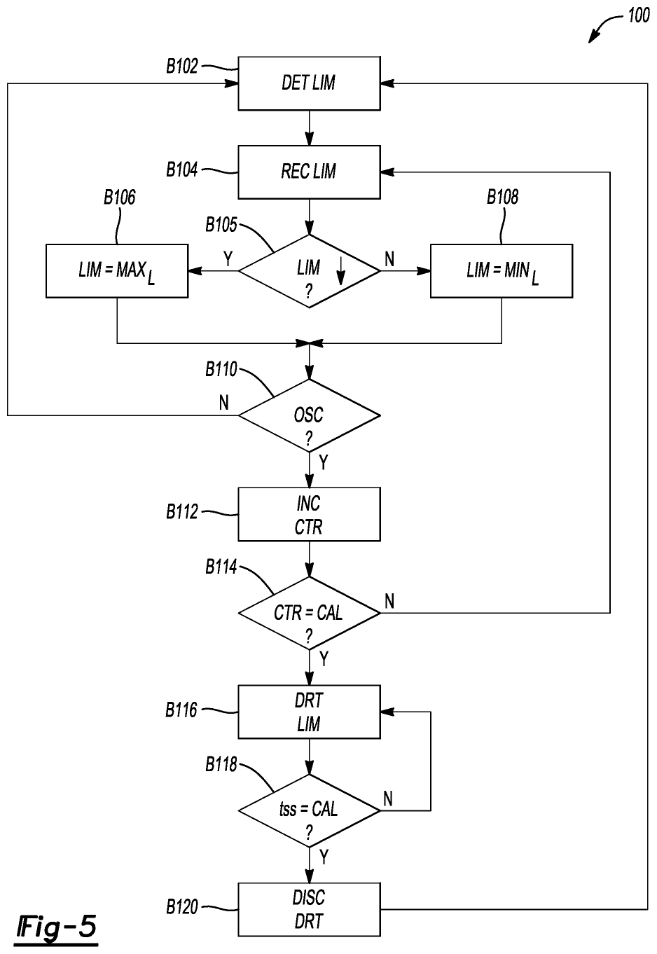

Referring to FIG. 5, the method 100 may be described in terms of corresponding code segments or logic/terminal blocks that are embodied as computer-readable instructions and executable by the vehicle controller 40 of FIG. 1. While power limits are used in this example, other limits such as charging current limits may be used in other implementations. In general, the method 100 in its various embodiments proceeds in response to a connection of the propulsion battery pack 12 of FIG. 1 to the offboard charging station 20. After this connection has been established, the vehicle controller 40 receives a reported charging limit (LIM) from the station controller 400 of the offboard charging station 20, and also transmits an initial charging request (CC_{REQ-ORIG}) to the station controller 400 as a request for charging power or current at the reported charging limit.

The vehicle controller 40 in a possible implementation detects a threshold oscillation of the reported charging limit (LIM) during an active charging event, during which the propulsion battery pack 12 is recharged via the offboard charging station 20. In other approaches the station controller 400 could self-monitor for its own oscillations. In response to the threshold oscillation, the vehicle controller 40 temporarily reduces the initial charging current request (CC_{REQ-ORIG}) to a lower/derated level during the active charging event. In the station-based/self-monitoring alternative approach, the station controller 400 could preemptively lower its charging limits, for example by applying a secondary limit to avoid operating near threshold points corresponding to such oscillations. In such an embodiment, the station controller 400 would then communicate a new overall limit to the vehicle controller 40 to avoid possible issues with not delivering the requested charging power or current.

In the non-limiting embodiment of FIG. 5 in which the derating efforts are performed aboard the motor vehicle 10 of FIG. 1, and commencing with block B102 (“DET LIM”), the vehicle controller 40 upon establishing communications with the charging station 20 detects the charging limits (LIM) from the offboard charging station 20. Block B102 may entail receiving an electronic signal from the offboard charging station 20 over the cable 15 of FIG. 1 indicative of the charging limits, e.g., a maximum charging power or current level as appreciated in the art. The method 100 then proceed to block B104.

Block B104 (“REC LIM”) entails recording the reported charge limits (LIM) from block B102 in memory 44 of the vehicle controller 40, in this instance as a local maximum. The method 100 then proceed to block B105.

At block B105 (“LIM ↓”), the vehicle controller 40 determines if the recorded power limits from block B104 have dropped by a predetermined amount over a calibrated duration, i.e., whether the power limits have exhibited a calibrated rate of change (ROC). To this end, the vehicle controller 40 may be configured to count the number of step-like oscillations in the reported charging limit (LIM) over a predetermined duration as the ROC, and to detect the threshold oscillation by comparing the ROC to a calibrated ROC value. The method 100 proceeds to block B106 if the power limits have exhibited the calibrated ROC. Otherwise, the method 100 proceeds to block B108.

Block B106 (“LIM=MAX_{L}”) of FIG. 5 includes recording the prior charge limit as a local maximum point in memory 44. The method 100 then proceeds to block B110.

At block B108 (“LIM=MIN_{L}”), the vehicle controller 40 determines whether the recorded power limits have increased by a predetermined amount over the calibrated duration, i.e., if the ROC of the charging limits (LIM) exceeds a calibrated ROC. If so, the vehicle controller 40 records the prior-reported limits as a local minimum point. The method 100 then proceeds to blocks B102 and B110.

Block B110 (“OSC?”) includes comparing the recorded local maximum and minimum points from blocks B106 and B108 to a calibrated window of the originally-recorded maximum/minimum points to determine if the observed behavior corresponds to an oscillation. For example, the threshold oscillation could be at least 5 percent of the maximum power or current limit, such as a 10 kW oscillation in a representative 200 kW power limit. If so, the method 100 proceeds to block B112. The method 100 proceeds in the alternative to block B102 when the observed power limit behavior, even if noisy, does not correspond to an oscillation.

Block B112 (“INC CTR”) includes incrementing an oscillation counter of the vehicle controller 40, e.g., an integer counter. The method 100 then proceeds to blocks B102 and B114.

At block B114 (“CTR=CAL?”), the vehicle controller 40 next compares the counter value of the oscillation counter used in block B112 to a calibrated counter threshold, i.e., an application-specific integer value. Block B114 is used to determine if the number of oscillations in the communicated charging limits warrants intervention by the vehicle controller 40. The method 100 proceeds to block B116 if the count threshold has been exceeded, and returns to block B104 in the alternative.

At block B116 (“DRT LIM”), the vehicle controller 40 derates the current request (CC_{REQ}). This action entails stepping down the charge request (CC_{REQ}) to a lower level, as best shown at 65 in FIG. 4. That is, the vehicle controller 40 may be configured to record the above-noted local minimum point in detected oscillations in its memory 44, with the derated level of the charging current request (CC_{REQ}) being a corresponding charging power (or current) below the minimum point. As a part of block B116, when the vehicle controller 40 of FIG. 1 is in communication with the user device 25 of FIGS. 1 and 2, the vehicle controller 40 could optionally transmit the station status signal (CC_{STAT}) to the user device 25 that is indicative of the threshold oscillation. The vehicle controller 40 may then initiate a timer before proceeding to block B118.

Block B118 (“t_{SS}=CAL?”) includes determining via the vehicle controller 40 if the charging limits (LIM) communicated by the offboard charging station 20 have been in a non-oscillating/steady-state manner for a calibrated amount of time. That is, the vehicle controller 40 holds the derated level for a calibrated amount of time, such as about 1-2 minutes, and possibly resumes the initial charging current request (CC_{REQ}) when the calibrated amount of time has elapsed.

The method 100 proceeds to block B120 when the oscillations have stopped. The method 100 otherwise performs blocks B116 and B118 in a loop while oscillations continue, with the vehicle controller 40 evaluating the behavior of the charging station 20. In the event the oscillations continue, the vehicle controller 40 may continue to derate the charge current request (CC_{REQ}) by a calibratable amount until steady-state is successfully achieved, or at least until the vehicle controller 40 determines that the updated charge request (CC_{REQ}) is below a lower threshold, thus requiring a different control action such as terminating the charge event and transmitting a message to the user informing the user of the termination.

At block B120 (“DISC DRT”), the vehicle controller 40 removes the derate limits and thereby resumes the original higher power limits. The method 100 then resets to its initial state and returns to block B102, thereafter resuming monitoring for undesirable oscillating behavior.

As appreciated by those skilled in the art, existing approaches for detecting erratic or oscillating behavior of an EVSE charging station such as the offboard charging station 20 of FIG. 1 tend to be used solely to trigger diagnostic processes, with such processes often resulting in termination of the charging session. In contrast, the method 100 described above is intended to intervene in the power output level of the offboard charging station 20 by choosing a lower current request (CC_{REQ}) in order to avoid rapid power module toggling. The control programming for achieving such a result could be provided in the vehicle controller 40 or another local controller, i.e., an onboard solution, such that the vehicle controller 40 is responsive to the oscillations. Alternatively, the control programming could be provided in the station controller 400 such that the offboard charging station 20 proactively addresses its own oscillations via temporary enforcement of lower charging limits (LIM) and reporting of the same to the vehicle controller 40.

Oscillation-based control as contemplated herein provides various performance benefits. For instance, the solutions described above may reduce instances of false failures, improve the charging experience from the user's perspective, and improve the reliability of the offboard charging station 20. As some customers may prefer to monitor power limits from the offboard charging station 20 via a display screen, e.g., of an in-vehicle infotainment system, a smart phone, laptop, tablet, or wearable computer device, use of the method 100 as set forth herein should provide a charging experience that is much closer to a steady-state ideal. Depending on the station-specific issue, the present solutions could also increase the available charge rate. Similarly, use of the method 100 could help increase the durability of the offboard charging station 20 by avoiding the underlying source of undesirable oscillations, i.e., the rapid switching of power modules. These and other attendant benefits will be recognized by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. An electrified powertrain system, comprising:
a battery pack;
an electric motor connected to and energized by the battery pack; and
a local controller configured, in response to a connection of the battery pack to an offboard charging station having a station controller, to:
receive a reported charging limit from the station controller;
transmit an initial charge request signal to the station controller, wherein the initial charge request signal is a request for charging power or current at the reported charging limit;
detect a threshold oscillation of the reported charging limit during an active charging event during which the battery pack is recharged via the offboard charging station; and
in response to the threshold oscillation, temporarily reduce the initial charge request to a derated level during the active charging event.

2. The electrified powertrain system of claim 1, wherein the reported charging limit includes a maximum charging power limit of the offboard charging station, and wherein the initial charge request is a request for the charging power at the maximum charging power limit.

3. The electrified powertrain system of claim 1, wherein the local controller is configured to count a number of step-like oscillations in the reported charging limit over a predetermined duration as a rate of change (ROC), and to detect the threshold oscillation by comparing the ROC to a calibrated ROC value.

4. The electrified powertrain system of claim 1, wherein the local controller is configured to:
hold the derated level for a calibrated amount of time; and
resume the initial charge request when the calibrated amount of time has elapsed.

5. The electrified powertrain system of claim 1, wherein the local controller is configured to detect the threshold oscillation by recording a minimum point in the oscillations in memory of the local controller, and wherein the derated level is below the minimum point.

6. The electrified powertrain system of claim 1, wherein the electrified powertrain system is used aboard a motor vehicle having a set of road wheels, the battery pack is a propulsion battery pack of the motor vehicle, and the electric motor is connected to one or more of the road wheels.

7. The electrified powertrain system of claim 1, wherein the threshold oscillation is at least 5 percent of the maximum power or current limit.

8. The electrified powertrain system of claim 1, wherein the local controller is in communication with a user device and configured to transmit a station status signal to the user device that is indicative of the threshold oscillation.

9. A method for charging a battery pack of an electrified powertrain system, comprising:
receiving a reported charging limit from a station controller of an offboard charging station in response to a connection of the battery pack to the offboard charging station;
transmitting an initial charge request to the station controller via a local controller of the electrified powertrain system, wherein the initial charging current request is a request for charging power or current at the reported charging limit;
detecting a threshold oscillation of the reported charging limit, via the local controller, during an active charging event during which the battery pack is recharged via the offboard charging station; and
in response to the threshold oscillation, temporarily reducing the initial charge request to a derated level via the local controller during the active charging event.

10. The method of claim 9, wherein the reported charging limit includes a maximum charging power limit of the offboard charging station, and wherein transmitting the initial charge request includes transmitting a request for the charging power at the maximum charging limit.

11. The method of claim 9, further comprising:
counting, via the local controller, a number of step-like oscillations in the reported charging limit over a predetermined duration as a rate of change (ROC); and
detecting the threshold oscillation by comparing the ROC to a calibrated ROC value.

12. The method of claim 9, further comprising:
holding the derated level at a steady-state level for a calibrated amount of time; and
resuming the initial charge request when the calibrated amount of time has elapsed.

13. The method of claim 9, wherein detecting the threshold oscillation of the reported charging limit includes recording a minimum point in the oscillations in memory of the local controller, and wherein the derated level is a charging power or current that is below the minimum point.

14. The method of claim 9, wherein detecting the threshold oscillation of the reported charging limit oscillation includes detecting an oscillation of at least 5 percent of the maximum power or current limit.

15. The method of claim 9, wherein the local controller is in communication with a user device, further comprising:
transmitting a station status signal to the user device via the local controller, the station status signal being indicative of the threshold oscillation.

16. A method for charging a battery pack of an electrified powertrain system, comprising:
receiving, via a first controller, an initial charge request from a second controller while the battery pack is connected to an offboard charging station;
detecting a threshold oscillation of a charging limit of the offboard charging station, via the first controller or the second controller, during an active charging event during which the battery pack of the electrified powertrain system is recharged by the offboard charging station; and
in response to the threshold oscillation, temporarily reducing the charging limit of the offboard charging station to a derated charging limit during the active charging event.

17. The method of claim 16, wherein the offboard charging station includes a station controller as the first controller, and wherein detecting the threshold oscillation of the charging limit and temporarily reducing the charging limit to the derated charging limit are performed by the station controller.

18. The method of claim 17, wherein the station controller is in communication with a user device, the method further comprising:
transmitting a station status signal to the user device via the station controller, the station status signal being indicative of the threshold oscillation and the derated charging limit.

19. The method of claim 16, wherein:
the electrified powertrain system is a component of a motor vehicle having a vehicle controller, a vehicle body, a set of road wheels connected to the vehicle body, and an electric traction motor connected to one or more of the road wheels and energized by the battery pack;
the first controller is a station controller of the offboard charging station; and
the second controller is the vehicle controller.

20. The method of claim 17, wherein the station controller is configured to count a number of step-like oscillations in the reported charging limit over a predetermined duration as a rate of change (ROC), detect the threshold oscillation by comparing the ROC to a calibrated ROC value, hold the derated charging limit for a calibrated amount of time, and resume the initial charging current request when the calibrated amount of time has elapsed.
